(19) United States
(12) Patent Application Publication
(10) Pub. No.: US 2021/0181736 A1
(43) Pub. Date: Jun. 17, 2021

(54) ON DEMAND AUTONOMOUS VEHICLE APPLICATION AND SERVICE

(71) Applicant: MASTERCARD INTERNATIONAL INCORPORATED, Purchase, NY (US)

(72) Inventors: Eugene REDA, Little Falls, NJ (US); Skyler FOX, Park Ridge, NJ (US); Marek KURYLKO, Bloomfield, NJ (US)

(21) Appl. No.: 16/716,148

(22) Filed: Dec. 16, 2019

(51) Int. Cl. G05D 1/00; G06F 16/9035; G06F 9/54

(52) U.S. Cl. CPC G05D 1/0044; G05D 1/0088; G05D 2201/0213; G06F 9/541; G06F 16/9035

(57) ABSTRACT

An on demand autonomous vehicle application (“AV application”) and service (“AV service”) is provided. The AV service can obtain consumer parameters for an autonomous vehicle use case defined by a user and map the consumer parameters to an available autonomous vehicle. The AV service can map the consumer parameters to the available autonomous vehicle by querying a data resource for registered autonomous vehicles that satisfy baseline criteria using at least one of the consumer parameters to obtain a scoped set of autonomous vehicles; obtaining current state information for each autonomous vehicle of the scoped set of autonomous vehicles; and identifying an autonomous vehicle of the scoped set of autonomous vehicles as the available autonomous vehicle when the current state information of that autonomous vehicle satisfies the autonomous vehicle use case. The AV service can then provide information of the available autonomous vehicle that is mapped to the consumer parameters.

### BACKGROUND

An autonomous vehicle refers to a vehicle that is capable of sensing its environment and moving safely with little or no human input. Autonomous vehicles are able to perceive what is going on in their surroundings and travel to different locations through a combination of sensors, cameras, radar and artificial intelligence. Advanced control systems can interpret sensory information to detect obstacles and choose the most appropriate navigation path for the vehicle.

An autonomous vehicle is also known as a driverless vehicle, robot vehicle, or self-driving vehicle. Examples of autonomous vehicles include, but are not limited to, aerial vehicles (e.g., drones with autopilot), self-driving passenger vehicles, and self-driving commercial vehicles and cargo trucks.

### BRIEF SUMMARY

On demand autonomous vehicle applications (“AV application”) and services (“AV service”) are provided. The AV application and service facilitate communication with the autonomous vehicles themselves, via the applicable APIs, to summon an appropriate autonomous vehicle to where the user or cargo is and actually pilot that vehicle or instruct that vehicle to pilot itself to a destination or to do a particular task.

An AV service can obtain consumer parameters for an autonomous vehicle use case defined by a user and map the consumer parameters to an available autonomous vehicle. The AV service can map the consumer parameters to the available autonomous vehicle by querying a data resource for registered autonomous vehicles that satisfy baseline criteria using at least one of the consumer parameters to obtain a scoped set of autonomous vehicles; obtaining current state information for each autonomous vehicle of the scoped set of autonomous vehicles; and identifying an autonomous vehicle of the scoped set of autonomous vehicles as the available autonomous vehicle when the current state information of that autonomous vehicle satisfies the autonomous vehicle use case. The AV service can then provide information of the available autonomous vehicle that is mapped to the consumer parameters. The AV service communicates with registered autonomous vehicles via their corresponding APIs to facilitate and coordinate autonomous vehicle usage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A and 1B illustrate example operating environments for an on demand autonomous vehicle application and service.

FIG. 2 illustrates an example process flow diagram for providing on demand autonomous vehicles.

FIG. 3A illustrates an example owner autonomous vehicle enrollment process.

FIG. 3B illustrates examples of owner autonomous vehicle enrollment options.

FIGS. 4A-4C illustrate snapshots of an example user interface showing owner-view features that can be provided by an on demand autonomous vehicle application and service.

FIG. 5A illustrates an example user autonomous vehicle registration process.

FIG. 5B illustrates examples of user autonomous vehicle registration options.

FIGS. 6A-6C illustrate snapshots of an example user interface showing a user scenario of an on demand autonomous vehicle application.

FIGS. 7A-7C illustrate snapshots of an example user interface showing a user scenario of an on demand autonomous vehicle application.

FIG. 8 illustrates components of an example computing device that may be carry out the described processes.

FIG. 9 illustrates components of an example computing system that may be used to implement certain methods and services described herein.

### DETAILED DESCRIPTION

On demand autonomous vehicle applications and services are provided. An autonomous vehicle refers to a vehicle that is capable of sensing its environment and moving safely with little or no human input. Examples of autonomous vehicles include, but are not limited to, aerial vehicles (e.g., drones with autopilot), self-driving passenger vehicles, and self-driving commercial vehicles and cargo trucks.

Owners of autonomous vehicles typically only use these vehicles for small increments of time. The rest of the time, the autonomous vehicles sit idle. Even as the “gig economy” has enabled individuals to monetize their own downtime and dormant/unused assets, owners may not be able to easily monetize their autonomous vehicles. Likewise, consumers, businesses, and government agencies may not easily access autonomous vehicle assets without purchasing them outright. An on demand autonomous vehicle platform, including applications and services, can leverage underused resources for transportation of users and cargo.

Through the described on demand autonomous vehicle applications and services, autonomous vehicles can be made available for use by end users “users” (consumers, businesses, or government agencies) on demand.

It should be understood that any usage of an autonomous vehicle will follow the rules and regulations of the respective jurisdictions (federal/national level and state level in the United States), in which the operation actually takes place.

The on demand autonomous vehicle application and service facilitates communication with the autonomous vehicles themselves, via the applicable APIs, to summon the autonomous vehicle to where the end user is or where the cargo is that needs to be transported and actually pilot that vehicle or instruct that vehicle to pilot itself to a destination or to do a particular task (e.g., navigate to critical waypoints for a given task). Coordination of resources is possible.

A defined input flow is provided to enable owners of autonomous vehicles to register and characterize their vehicles. Owners can also define availability and other options with respect to the registered vehicles. The types of autonomous vehicles that the on demand autonomous vehicle application and service can manage and coordinate may include, but are not limited to, self-driving cars, drones, self-driving commercial vehicles and cargo trucks, etc.

A defined flow is also provided to enable end users (consumers, businesses, government agencies, etc.) to register and characterize their profiles by location, general needs, etc. End users of the described on demand autonomous vehicle applications can then access registered autonomous vehicles by performing a search for particular use case characteristics.

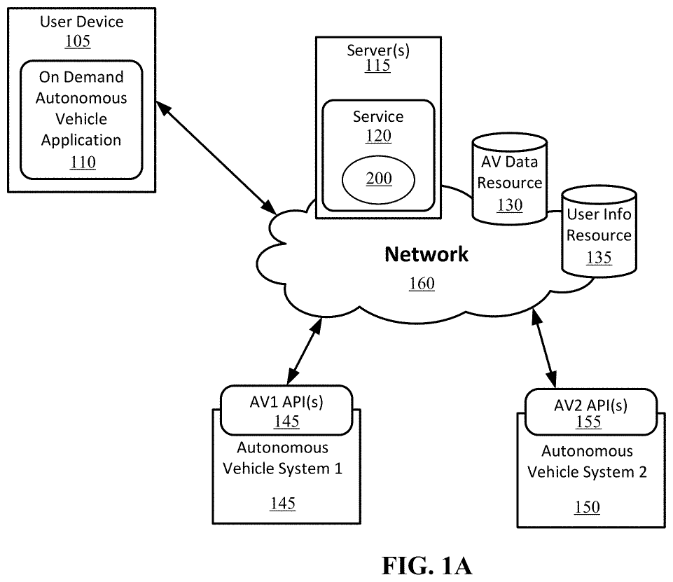

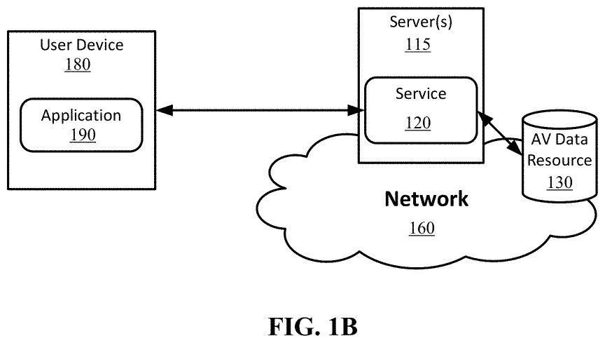

FIGS. 1A and 1B illustrate example operating environments for an on demand autonomous vehicle application and service; and FIG. 2 illustrates an example process flow diagram for providing on demand autonomous vehicles.

Referring to FIG. 1A, the example operating environment may include a user device 105 running an on demand autonomous vehicle application (“AV application”) 110, an on demand autonomous vehicle server (“AV server”) 115 implementing an on demand autonomous vehicle service (“AV service”) 120, and one or more structured resources, such as autonomous vehicle data resource (“AV data resource”) 130 and user information data resource 135. The example operating environment may also include one or more autonomous vehicle systems and their corresponding APIs, such as autonomous vehicle system 1 140 with corresponding AV1 API(s) 145 and autonomous vehicle system 2 150 with corresponding AV2 API(s) 155.

The example operating environment allows the AV service 120 to communicate with multiple autonomous vehicle systems via their corresponding APIs. For example, AV service 120 can communicate with AV system 1 140 via AV1 APIs 145 and AV system 2 150 via AV2 APIs 155.

Examples of autonomous vehicle systems include, but are not limited to, aerial vehicles, self-driving passenger vehicles, self-driving and cargo trucks.

Through the corresponding APIs, the AV service 120 can receive information, such as current state information, for the autonomous vehicle in order to map consumer parameters to available autonomous vehicles, as well as enable action by a selected autonomous vehicle.

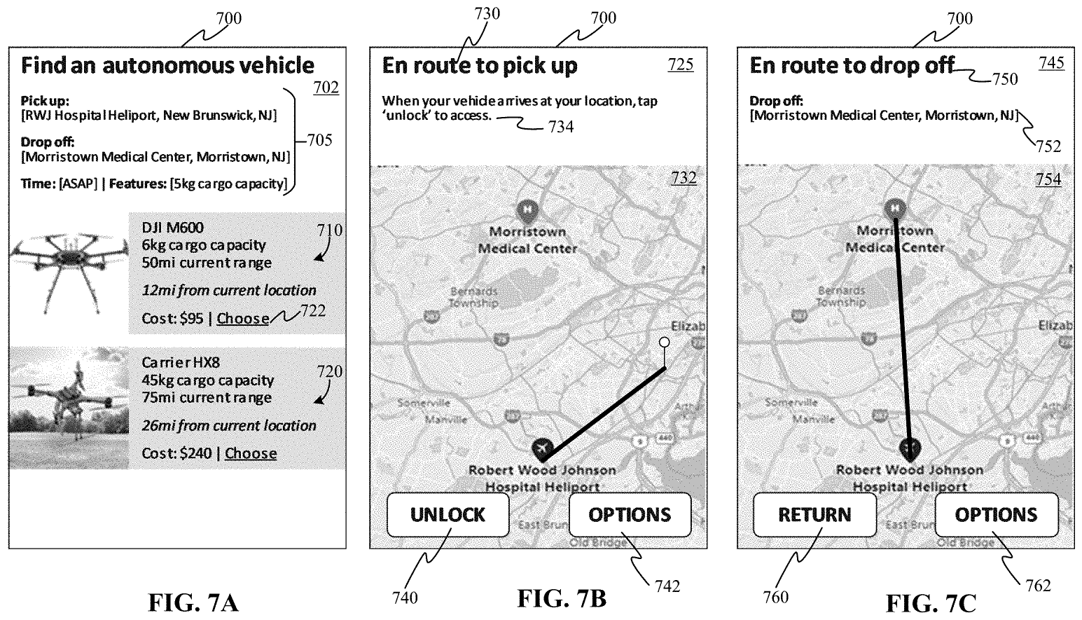

User device 105 may be a computing device such as described with respect to system 800 of FIG. 8. The user device 105 can be, but is not limited to, a personal computer (e.g. desktop computer), laptop, personal digital assistant (PDA), video game device, mobile phone (or smart phone), tablet, slate, terminal, holographic-enabled device, and the like. It should be apparent that the user device 105 may be any type of computer system that provides its user the ability to load and execute software programs and the ability to access a network, such as network 160.

The AV application 110 can be stored on the user device 105 (e.g., a client-side application) or accessed as a web-based AV application (e.g., running on a server or hosted on a cloud) using a web browser (e.g., a standard Internet browser), and the application's interface may be displayed to the user within the web browser. Thus, the application may be a client-side application and/or a non-client side (e.g., a web-based) application. The AV application 110 can communicate with AV service 120 implemented on the AV server 115. The AV service 120 can carry out process 200 described with respect to FIG. 2.

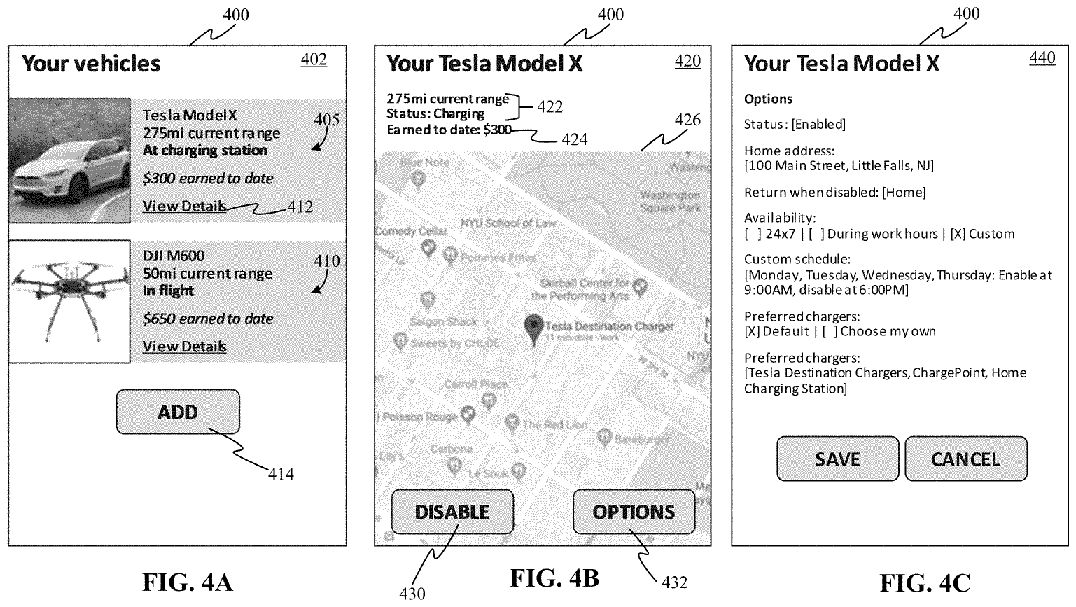

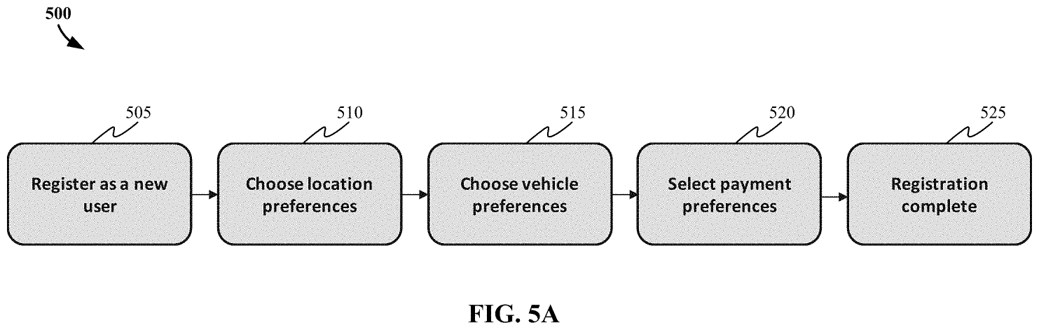

The user information data resource 135 includes user information and preferences for a plurality of users. The user information and preferences can include, but are not limited to, a type of user, location preferences, vehicle preferences, payment preferences, and verification information (e.g., licensing information).The user information and preferences may be collected and stored in the user information data resource 135 during a user on demand autonomous vehicle registration process (e.g., process 500 described with respect to FIG. 5A). Examples of the user on demand autonomous vehicle registration process are provided with respect to FIGS. 5A and 5B.

The AV data resource 130 stores information on a plurality of registered autonomous vehicles, each registered autonomous vehicle having autonomous vehicle information. The autonomous vehicle information can include autonomous vehicle parameters, such as, but is not limited to, a type or a make/model, autonomous vehicle features and capabilities (e.g., built-in features, range, and payload capacity), location information (e.g., home base information), access and availability information (e.g., when and where the autonomous vehicle can be used, charger compatibility, and charging station locations). The autonomous vehicle information can also include corresponding autonomous vehicle APIs, state information, an image of the autonomous vehicle, and verification and/or licensing requirements (e.g., government agency credentials).

The state information can include, but is not limited to, a status (e.g., charging, en route, on ride, or in flight), a range, a location, and an availability. In some cases, the state information has an expiration date. For example, the state information may be stored with a timestamp; and after a certain amount of time has passed since the time of the timestamp, the state information can be considered expired state information. The AV service 120 can update the state information stored in the AV data resource 130 through communication with the autonomous vehicle systems via their corresponding APIs (e.g., AV system 1 140 via AV1 APIs 145 and AV system 2 150 via AV2 APIs 155).

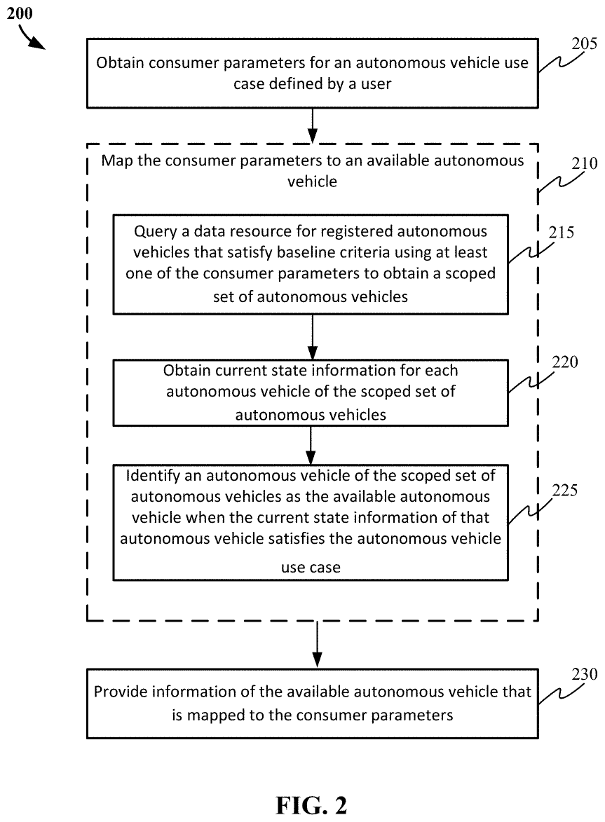

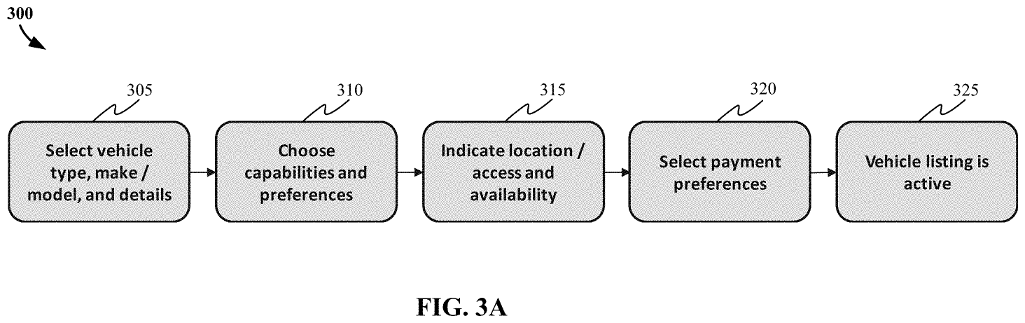

In some cases, the autonomous vehicle information is collected and stored in the AV data resource 130 during an owner enrollment process (e.g., owner enrollment process 300 described with respect to FIG. 3A) via the operating environment described in FIG. 1B. Examples of the owner enrollment process are described with respect to FIGS. 3A and 3B.

Referring to FIG. 1B, the example operating environment may include a user device 180 running an application 190, the AV server 115 implementing AV service 120, and one or more structured resources, such as the AV data resource 130. The application 190 may be the AV application 110 or a portal or other interface accessible through, for example, an Internet browser executing on the user device 180.

The example operating environment of FIG. 1B allows an autonomous vehicle owner to enroll autonomous vehicles with the system. During enrollment of an autonomous vehicle, the owner enters or selects vehicle parameters and payment preferences via the application 190. The AV service 120 can store the vehicle parameters and payment preferences for the autonomous vehicle in the AV data resource 130.

The AV service 120 can also determine available corresponding APIs for the autonomous vehicle. In some cases, the APIs for a given autonomous vehicle will be known to the AV service 120 and stored in the AV data resource 130.

For example, Tesla vehicles have some known APIs. Examples of APIs available for autonomous vehicles from Tesla include commands to “unlock doors” and “honk horn.” The unlock doors command can be used to unlock the doors of the vehicle for user access. An example of the unlock doors command API is https://owner-api.teslamotors.com/api/1/vehicles/:id/command/door_unlock. The honk horn command can be used to honk the horn of the vehicle once. An example of the honk horn command API is “https: Howner-api.teslamotors.com/api/1/vehicles/:id/command/honk horn.”

In some cases, the autonomous vehicle can use standard API specifications not specific to that vehicle or manufacturer. An example of APIs with a standardized specification includes the suite of open-source resources made available by Dronecode Project, such as DroneCode SDK. The DroneCode SDK is a MAVLink Library for PX4. DroneCode SDK provides a simple API for managing one or more autonomous vehicles, providing programmatic access to autonomous vehicle information and telemetry, and control over missions, movement, and other operations. Accordingly, the AV service 120 may be able to control a PX4 drone via DroneLink SDK/APIs.

In some cases, ‘mission’ objects can be used to direct a drone to set coordinates and perform simple actions. DJI drones may accept different types of ‘mission’ inputs. For example, a ‘waypoint’ mission could be used for cargo transportation and a ‘hotpoint’ mission could be used to record video or photos of an event in a given location.

These references to standard API specifications can also be stored in the AV data resource 130 once they are known.

In some cases, the autonomous vehicle may be unknown the AV service 120 (e.g., if the APIs are not already stored in the AV data resource 130). In some cases, if an API specification known to the API service 120 can be applied to the unknown vehicle, the owner attempting to enroll the autonomous vehicle can select a standardized API specification. In other cases, the owner attempting to enroll the autonomous vehicle can submit a request for manual integration of the unknown vehicle with the AV service 120.

Components (computing systems, storage resources, and the like) in the operating environments described in FIGS. 1A and 1B may operate on or in communication with each other over the network 160. The network can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art. 100441 Communication to and from the components may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

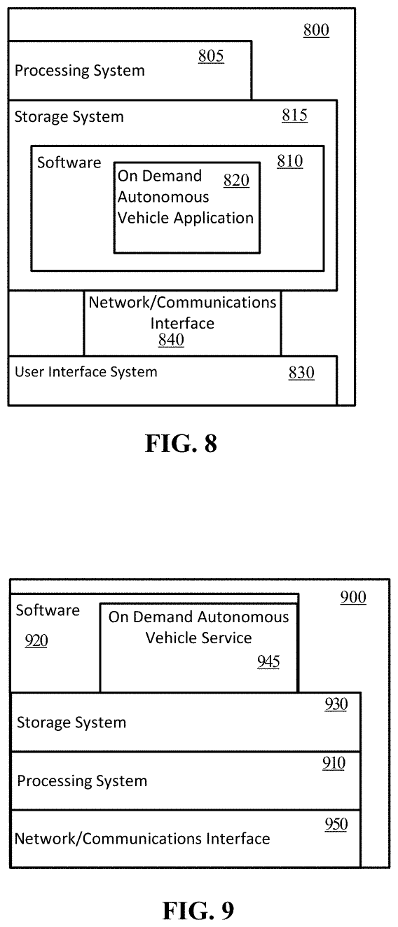

Referring to FIG. 1A and FIG. 2, an on demand autonomous vehicle service, such as AV service 120, performing process 200, can be implemented by an on demand autonomous vehicle server, such as AV server 115, which can be embodied as described with respect to computing system 900 as shown in FIG. 9 and even, in whole or in part, by computing system 800 as described with respect to FIG. 8.

During run-time, the AV service 120 can obtain (205) consumer parameters for an autonomous vehicle use case defined by a user. The user can be any registered user, for example, a personal user, a small business user, a large business user, or a government agency user.

The autonomous vehicle use case may be any suitable use case. For example, a government agency may want to use a drone with a built-in camera for help with surveying a piece of land. In another example, an event management company may want to use a drone with a built-in video camera to record and photograph an event, such as a concert or festival, for use in promoting the event on social media. In another example, a personal user may want to use a self-driving car as a shuttle to get from across town. In yet another example, a large business may want to use a cargo truck that can transport 50,000 pounds of cargo a distance of 250 miles.

The consumer parameters can include action information, location information, time information, passenger information, cargo information, feature information, or a combination thereof.

The action information can indicate what actions the autonomous vehicle should perform during usage. For example, the action information can indicate that the autonomous vehicle should provide a ride for passengers, transport cargo, or take a photo or record a video of a certain location.

The location information can include, for example, a pick-up location, a drop-off location, or a current location. The time information can include, for example, a time in which a passenger or cargo is to be picked-up. The passenger information can include, for example, the number of passengers. The cargo information can include, for example, a type of cargo being transported, or an amount of cargo being transported. The feature information can include any additional features or capabilities required of the autonomous vehicle in order to complete the autonomous vehicle use case, such as a built-in camera.

In some cases, one or more of the consumer parameters are obtained by the AV service 120 while the user is defining the autonomous vehicle use case, for example, by the user selecting certain consumer parameters in a user interface of the AV application 110 or by the application 110 capturing user-approved information such as user location. In some cases, one or more of the consumer parameters are obtained from the user information data resource 135.

In some cases, the AV service 120 may extrapolate or interpolate additional consumer parameters beyond what the consumer has explicitly provided. As an illustrative example, if the user input specifies ‘transport package from Brooklyn, N.Y. to Paterson, N.J. using drone,’ AV service 120 can add additional distance data based on no-fly zones over NY state parks. Similar logic could apply as routes are calculated for self-driving cars. For example, construction zones or traffic would dictate the need for additional range.

The AV service 120 can map (210) the consumer parameters to an available autonomous vehicle. The AV service 120 can map (210) the consumer parameters via steps 215, 220, and 225. In some cases, the consumer parameters are mapped to multiple available autonomous vehicles.

In the illustrative example, the AV service 120 can query (215) a data resource (e.g., the AV data resource 130) for registered autonomous vehicles that satisfy baseline criteria using at least one of the consumer parameters to obtain a scoped set of autonomous vehicles.

The AV service 120 can search through the autonomous vehicle information stored in the AV data resource 130 to filter out any available autonomous vehicles that, as a baseline, do not have the capabilities to serve the autonomous vehicle use case defined by the user. For example, if one of the consumer parameters of the autonomous vehicle use case indicates that the type of autonomous vehicle desired is a drone, the AV service 120 can identify, through the autonomous vehicle information, a scoped set of autonomous vehicles that includes only drones.

In another example, if one or more of the consumer parameters of the autonomous vehicle use case indicate that the type of autonomous vehicle desired is a commercial truck with a cargo capacity of 50,000 pounds, the AV service 120 can obtain a scoped set of autonomous vehicles that includes only commercial trucks that can carry 50,000 pounds or more.

The AV service 120 can obtain (220) current state information for each autonomous vehicle of the scoped set of autonomous vehicles. The current state information can include, but is not limited to, a current status (e.g., charging, en route, on ride, or in flight), a current range, a current location, and a current availability. The AV service 120 can communicate with one or more of the autonomous vehicles of the scoped set of autonomous vehicles via their corresponding APIs to obtain the current state information. Advantageously, the scoped set of autonomous vehicles optimizes the number of autonomous vehicles in which the AV service 120 needs to obtain current state information.

In some cases, the AV service 120 obtains the current state information in real time directly from the autonomous vehicle itself via corresponding APIs. For example, an autonomous vehicle may indicate, through corresponding APIs, that the autonomous vehicle is currently parked at a home base charging station and currently has a 200-mile range. As another example, an autonomous vehicle can indicate, through corresponding APIs, that the autonomous vehicle is currently unavailable because the autonomous vehicle is in route to a drop-off location with four passengers and does not have room for another passenger.

In some cases, the AV service 120 obtains the current state information for each autonomous vehicle of the scoped set of autonomous vehicles by first determining whether a last known state information for each autonomous vehicle of the scoped set of autonomous vehicles has expired. For example, the AV service 120 can use the timestamp stored with the state information for the autonomous vehicle to determine whether a certain amount of time has passed.

For each autonomous vehicle of the scoped set of autonomous vehicles not having expired last known state information, the AV service 120 can use the last known state information as the current state information. For each autonomous vehicle of the scoped set of autonomous vehicles having expired last known state information, the AV service 120 can communicate with that autonomous vehicle via its corresponding APIs to obtain the current state information.

The AV service 120 identifies (225) an autonomous vehicle of the scoped set of autonomous vehicles as the available autonomous vehicle when the current state information of that autonomous vehicle satisfies the autonomous vehicle use case.

That is, once the AV service 120 obtains the current state information for an autonomous vehicle, the AV service 120 can determine if the current state information will satisfy the requirements of the autonomous vehicle use case. For example, if the autonomous vehicle use case indicates that a user needs to travel 100 miles, the AV service 120 will not summon a self-driving car that is only charged enough to go 75 miles. Instead, the AV service 120 will identify a self-driving car that has enough range to pick up the user at the user's current location and drop the user off at the desired destination with an amount of range that the autonomous vehicle currently has.

In some cases, the current state information is considered to satisfy the requirements of the autonomous vehicle use case when the autonomous vehicle information and the current state information matches each consumer parameter of the autonomous vehicle use case.

In some cases, the autonomous vehicle use case requires an autonomous vehicle to travel beyond a standard range. In this case, the autonomous vehicle can may satisfy the requirements of the autonomous vehicle use case by including a recharge at an intermediary charging location as part of the routing.

The AV service 120 can provide (230) information of the available autonomous vehicle that is mapped to the consumer parameters. In some cases, information of a plurality of available autonomous vehicles is provided.

The information provided may include an image of the available autonomous vehicle, current state information of the available autonomous vehicle, or any autonomous vehicle parameter of the available autonomous vehicle, such as a type and make/model of the available autonomous vehicle.

In some cases where a plurality of available autonomous vehicles is provided, the AV service 120 can receive a selection of one of the available autonomous vehicles. In some cases where one autonomous vehicle is provided, the AV service 120 can receive a selection indicating to proceed with the one autonomous vehicle. In response to receiving the selection, the AV service 120 can facilitate communication via the corresponding APIs of the selected autonomous vehicle to enable action by the selected autonomous vehicle.

The AV service 120 can facilitate communication via the corresponding APIs to enable action in a variety of ways. In some cases, the AV service 120 can communicate one or more of the consumer parameters, via the corresponding APIs, to the selected autonomous vehicle to enable the action. For example, to enable an action of shuttling a personal user from a pick-up location to a drop-off location, the AV service 120 can communicate consumer parameters such as location information (e.g., the pick-up location and the drop-off location) and desired action information (e.g., a transport a passenger from pick-up location to the drop-off location).

In some cases, the AV service 120 can communicate a script via the corresponding APIs to the selected autonomous vehicle. The script can be based on the autonomous vehicle use case defined by the user.

In an example where the autonomous vehicle use case defined by the user a drone is to transport cargo from location A to location B, the script could direct the drone to first go to location A, wait until a user hits the button for unlock and loads the cargo, then proceed to location B. In some cases, depending on the autonomous vehicle, the scripting may happen in the AV service 120. In some cases, the scripting would be passed directly to the autonomous vehicle via the corresponding APIs.

In some cases, the complexity of the APIs available for a given autonomous vehicle will determine the nature and complexity of the instructions given by the AV service 120. For example, a first API can receive and process complex missions (e.g. DJI mission structures), so the AV service 120 passes the criteria for those missions to the first API. In another example where a second API does not have the same capability as the first API, the AV service 120 breaks down the autonomous vehicle use case and consumer parameters into, for example, individual instructions, coordinates, altitudes, etc., and passes these detailed instructions to the API.

The AV service 120 can receive an option command while the selected autonomous vehicle is performing the action. Examples of option commands include, but are not limited to, a command to pause the action, a command to cancel or end the action, a command to change a pickup location, a command to change a drop off location, a command to unlock command, and a command to begin or continue action command.

The AV service 120 can facilitate communication via the corresponding APIs of the selected autonomous vehicle to enable the selected autonomous vehicle to perform the option command. In an example where, after a user begins a ride, the user selects the command to pause the ride, the AV service 120 can facilitate communication via the corresponding APIs of the selected autonomous vehicle to enable the selected autonomous vehicle to safely pull over to the side of the road.

In some cases, the method for injecting the option command (e.g., facilitating communication via the corresponding APIs to enable the selected autonomous vehicle to perform the option command) may differ depending on the nature of the autonomous vehicle API in use. In an example for a first API, the AV service 120 can cancel/pause the action and interject option commands or replace the existing action with a new action which incorporates/appends the new option input. In an example for a second API, the AV service 120 can insert the option command in the stream of detailed instructions the AV service 120 was already passing.

The AV service 120 can facilitate payment between the user and the autonomous vehicle owner (“owner”). Advantageously, the AV service 120 can provide the ability to characterize the payment terms that may not otherwise be accessible to these particular kinds of entities, both on the user side and on the owner side. In some cases, the AV the service 120 provides the ability to customize payment terms to enable payment directly from the user to the owner.

The payment may be facilitated in a variety of ways. The owner may select to receive payments from users, for example, via cryptocurrency, a transfer to a digital wallet, a deposit to a bank account, and an invoice against commercial or government contract. The user may select to provide payments via a credit card, a bank account, or selecting contract terms.

It should be understood that AV server 115 and AV service 120 may be provided by a single entity or by different entities. The information received, collected, and/or generated by the AV service 120 (such as found in the AV data resource 130 or user information data resource 135) may be stored on a same or different resource and even stored as part of a same data structure depending on implementation.

FIG. 3A illustrates an example owner autonomous vehicle enrollment process; and FIG. 3B illustrates examples of owner autonomous vehicle enrollment options. Owners of autonomous vehicles can enroll their autonomous vehicles with the AV application and AV service through an enrollment process 300. During the enrollment process 300, the owner can compile and characterize an autonomous vehicle based on the vehicles various features and capabilities and make the autonomous vehicle active and available for users through the AV application. The autonomous vehicle information collected through the enrollment process 300 can be stored in a data resource, such as AV data resource 130 described with respect to FIGS. 1A and 1B.

Referring to FIG. 3A, the owner can select (305) the type, make and model, and additional details for each autonomous vehicle being enrolled. The types of autonomous vehicles may include, but are not limited to, self-driving cars, drones, self-driving commercial vehicles and cargo trucks.

The owner can choose (310) capabilities and preferences of each autonomous vehicle being enrolled. The capabilities and preferences of an autonomous vehicle include, but are not limited to, built-in features, such as built-in video cameras, ranges of the autonomous vehicle, and the maximum capacity of cargo.

The owner can indicate (315) location information, access information, and availability information for the autonomous vehicle. For example, the owner can indicate where the home base or charging port is located, days and times when the autonomous vehicle is available for use through the AV application, and how far autonomous vehicle can travel during usage.

The owner can select (320) payment preferences. Payment preferences include for example, a transfer to a digital wallet, pay with crypto currency, deposit to bank account, an invoice against commercial or government contract. Once the owner has registered and characterized their autonomous vehicle (via steps 305, 310, 315, and 320), the autonomous vehicle can be listed (325) as active.

In some cases, the owner may indicate verification and/or licensing requirements for the autonomous vehicle during the enrollment process 300. For example, access to higher value drones may require government agency credentials.

In some cases, the owner can indicate API specifications during the enrollment process 300. For example, the owner can indicate API specifications if the autonomous vehicle is not already known to the AV service, but is compatible with a known API specification (e.g. MAVLink). In another example, owners can register custom-built autonomous vehicles, if the custom-built autonomous vehicle use a standard API.

Referring to FIG. 3B, four illustrative examples of vehicle enrollments are shown. For the illustrative example of a first autonomous vehicle 330, the owner selected the vehicle type as “Autonomous quadcopter” or drone that has a built-in video camera and the make/model to be “DJI Mavic Pro.” In the illustrative example, the owner has specified that the capabilities and preferences of the first autonomous vehicle 330 include a “Built-in 4K video camera.” The selection of the built-in camera can allow a user looking for a drone that can record videos or take photographs to be able to select this autonomous vehicle.

In the illustrative example, the owner has indicated that the location/access and availability of the first autonomous vehicle 330 is “Summon remotely from anywhere 24/7.” In this case, “Summon remotely from anywhere 24/7” indicates that the owner does not have any specific time that they want to carve out for the first autonomous vehicle 330 to not be available, nor do they have any specific area that the first autonomous vehicle 330 needs to come from or return to.

Continuing the illustrative example, for the payment preferences related to the first autonomous vehicle 330, the owner has selected “Transfer to digital wallet.” In this case, the owner can specify a particular digital wallet, register that digital wallet with the owners account, and indicate that they want the payments to be automatically transferred into that digital wallet as they become available.

Once the owner has compiled and characterized the first autonomous vehicle 330 based on the various features and capabilities of the first autonomous vehicle 330, the first autonomous vehicle 330 becomes active on the AV application and is available for users with matching use cases to use.

For the illustrative example of a second autonomous vehicle 340, the owner selected the vehicle type as “Other autonomous aerial vehicle” and the make/model to be “AAI RQ-7 Shadow.” In this case, the second autonomous vehicle 340 is a very large industrial payload carrying drone. Thus, the owner can specify the weight of the payload that the second autonomous vehicle 340 is able to carry. In the illustrative example, the owner has specified that the capabilities and preferences of the second autonomous vehicle 340 include “Carries payloads<50 lbs.”

In the illustrative example, the owner has indicated that the location/access and availability of the second autonomous vehicle 340 is “Unlock, take off, and return at local air strip.” In this case, the location/access and availability indicate that the second autonomous vehicle 340 needs to be kept at a particular take off location (the local airstrip); would be available within a particular radius of that airstrip; and then would return to that airstrip at the end of a case.

Continuing the illustrative example, for the payment preferences related to the second autonomous vehicle 340, the owner has selected “Pay with cryptocurrency.” In this case, the owner can configure a digital wallet to be paid with a particular cryptocurrency.

Once the owner has compiled and characterized the second autonomous vehicle 340 based on the various features and capabilities of the second autonomous vehicle 340, the second autonomous vehicle 340 becomes active on the AV application and is available for users with matching use cases to use.

For the illustrative example of a third autonomous vehicle 350, the owner selected the vehicle type as “Self-driving passenger vehicle” and the make/model to be “Tesla Model S.” In the illustrative example, the owner has specified in the capabilities and preferences that the third autonomous vehicle 350 has “250 mi range on full charge.” As previously described, through the corresponding APIs, the third autonomous vehicle 350 can indicate its current range at any given time.

In the illustrative example, the owner has indicated that the location/access and availability of the third autonomous vehicle 350 is “Unlock in nearby parking space.” In this case, the location/access and availability indicate that the third autonomous vehicle 350 has a home base of a nearby parking space and that the third autonomous vehicle 350 would return to that home base after completing a use case.

Continuing the illustrative example, for the payment preferences related to the third autonomous vehicle 350, the owner has selected “Deposit to bank account.” In this case, the owner can receive payment as a direct deposit into any bank account.

Once the owner has compiled and characterized the third autonomous vehicle 350 based on the various features and capabilities of the third autonomous vehicle 350, the third autonomous vehicle 350 becomes active on the AV application and is available for users with matching use cases to use.

For the illustrative example of a fourth autonomous vehicle 360, the owner selected the vehicle type as “Self-driving commercial truck” and the make/model to be “TuSimple self-driving tractor.” The owner has specified, in the capabilities and preferences, that the third autonomous vehicle 360 has “15,500 lb TW capacity.”

In the illustrative example, the owner has indicated that the location/access and availability of the fourth autonomous vehicle 360 is “Summon to your warehouse loading dock.” Advantageously, the AV application can make a self-driving commercial truck available on demand, for example, to a business that may need to schedule (rapidly) the ability to transport cargo to a different location without necessarily having to commit to an ongoing contract with a cargo transfer company. It specifies the amount of capacity that the attached trailer has and then the business can summon the truck directly to any warehouse that would have a loading dock.

Continuing the illustrative example, for the payment preferences related to the fourth autonomous vehicle 360, the owner has selected “Invoice against commercial/gov't contract.” In some cases, the owner of the fourth autonomous vehicle 360 (self-driving commercial truck, is a business. In this case, the use of the fourth autonomous vehicle 360 may be invoiced against a commercial account, which may be set up with the AV application.

Once the owner has compiled and characterized the fourth autonomous vehicle 360 based on the various features and capabilities of the fourth autonomous vehicle 360, the fourth autonomous vehicle 360 becomes active on the AV application and is available for users with matching use cases to use.

It should be understood that the examples illustrated in FIGS. 3A and 3B are not a complete reference of all envisioned autonomous vehicles, capabilities, or preferences.

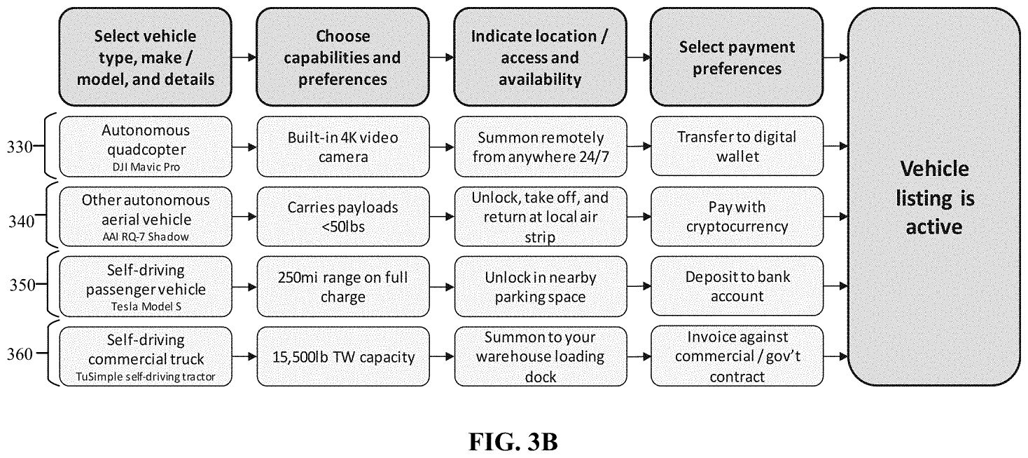

FIGS. 4A-4C illustrate snapshots of an example user interface showing owner-view features that can be provided by an on demand autonomous vehicle application and service. An owner can access an example user interface (“UI”) 400 showing the owner-view features through a user device running an application (e.g., user device 180 running application 190 described with respect to FIG. 1B). As previously described, the application may be an AV application or a portal or other interface accessible through an Internet browser executing on the user device. In some cases, the owner may first be asked to sign in to the AV application or portal (not shown).

Referring to FIG. 4A, the owner may be presented with a “Your vehicles” view 402 in the UI 400. Through the “Your vehicles” view 402, the owner may be able to view and manage any autonomous vehicles enrolled by the owner. In the illustrative example, the owner has two enrolled autonomous vehicles (e.g., a first autonomous vehicle 405 and a second autonomous vehicle 410).

Each enrolled autonomous vehicle is displayed, along with corresponding autonomous vehicle information. The corresponding autonomous vehicle information can include, but is not limited to, an image, make/model information, current state information, and an amount of money earned to date through the use of the autonomous vehicle. The current state information displayed to the owner can be real-time state information and can be obtained directly from the autonomous vehicle via corresponding APIs.

In the illustrative example, the first autonomous vehicle 405 is a “Tesla Model X” that has a “275 mi current range” and is currently located “at charging station.” The first autonomous vehicle 405 has “$300 earned to date.” The second autonomous vehicle 410 is a DJI M600 drone that has a “50 mi current range” and is currently “In flight.” The second autonomous vehicle 410 has “$650 earned to date.”

Each displayed enrolled autonomous vehicle also includes a command to view the details for that autonomous vehicle, such as view details command 412 for the first autonomous vehicle 405.

The “Your vehicles” view 402 of the UI 400, may include a command to add additional autonomous vehicles (e.g., add command 414). In some cases, selection of the command to add additional autonomous vehicles causes the UI 400 to display a separate UI (not shown) where the owner can complete an enrollment process, such as enrollment process 300 as described in FIG. 3A.

Referring to FIG. 4B, the owner has selected the view details command 412 for the first autonomous vehicle 405 within the “Your vehicles” view 402 of the UI 400 shown in FIG. 4A. In the illustrative example of FIG. 4B, the owner is presented with a detailed view of “Your Tesla Model X” (e.g., detailed view 420) in the UI 400. Through the detailed view 420 of the UI 400, the owner can view details for a specific autonomous vehicle.

In the illustrative example, the detailed view 420 provides a detailed view of the first autonomous vehicle 405. The detailed view 420 displays current state information 422 (e.g. current range and current status), an amount of money 424 earned to date through the use of the first autonomous vehicle 405, and a map 426 showing where the first autonomous vehicle 405 is currently located.

Certain menus and/or commands may be available to the owner via the detailed view 420. For example, the detailed view 420 of the UI 400 includes a disable command 430 and options command 432. The disabled command 430 can allow the owner to temporarily disable the first autonomous vehicle 405 or hide the first autonomous vehicle 405 from users. The options command 432 may be a command to view the options available to the owner for the autonomous vehicle.

Referring to FIG. 4C, the owner has selected the options command 432 for the first autonomous vehicle 405 within the detailed view 420 of the UI 400 shown in FIG. 4B. In the illustrative example of FIG. 4C, the owner is presented with an options view 440 of the UI 400. Through the options view 440, the owner can summon the autonomous vehicle to the current location of the owner, modify details and availability, or permanently remove the autonomous vehicle from the system.

It should be understood that other options may be included as appropriate for each autonomous vehicle type, location, and available technology.

FIG. 5A illustrates an example user autonomous vehicle registration process; and FIG. 5B illustrates examples of user autonomous vehicle registration options. Users can register to use the AV application through a user autonomous vehicle registration process 500 (“registration process”). During the registration process 500, the user can register as a new user and select various preferences, such as favorite locations and the type(s) of autonomous vehicles the user is interested in seeing. The user information collected through the registration process 500 can be stored in a data resource, such as user information data resource 135 described with respect to FIG. 1A.

Referring to FIG. 5A, the user can select (505) a type of user they would like to be registered as. The types of users may include, but are not limited to, a personal user, a small business user, a large business user, and a government agency user.

The user can choose (510) location preferences. The location preferences can include, for example, most commonly used locations (e.g., home and work), a business location, an agency location, and the ability to use a current location.

The user can choose (515) vehicle preferences. With the vehicle preferences, the owner can indicate the type(s) of vehicle the user would like to be shown. For example, the user may select to be shown passenger cars, drones, commercial trucks, or a combination thereof.

The user can select (520) payment preferences. Payment preferences include for example, adding a credit card, linking a bank account, or selecting contract terms. In some cases, the user can provide verification information, such as licensing information, in order to access autonomous vehicles requiring verification (e.g., government agency credentials). Once registration is complete (525), the user has access to the AV application and can request an autonomous vehicle on demand.

Referring to FIG. 5B, three illustrative examples of user registrations are shown. For the illustrative example of a first user 530, the first user 530 is looking for autonomous passenger vehicles to be able to transport the user from point A to Point B. In this case, the first user 530 selected to register as a “Personal user.” The first user 530 chose “Add home and work, use current location” as the location preferences and “Passenger cars” as the vehicle preference. For the payment preferences, the first user 530 chose to “Add credit card.”

In another illustrative example, a second user 540 is a small business interested in drones. For example, the second user 540 may be a wedding photographer looking for drones that can take photos of locations. As another example, the second user 540 may be a business that needs to perform deliveries locally and is interested in cargo drones.

In the illustrative example, the second user 540 selected to register as a “Small business owner.” The second user 540 chose “Add business locations” as the location preferences and “Drones” as the vehicle preference. For the payment preferences, the second user 540 chose to “Link bank account” to fund payments.

In yet another illustrative example, a third user 550 is a large business or a government agency that can have a wide variety of use cases that they may be looking to use this AV application for. For example, the third user 550 may be interested in everything from transporting people to transporting cargo through any variety of means.

In the illustrative example, the third user 550 selected to register as a “Large business or government agency.” The third user 550 chose “Add business/agency locations” as the location preferences and “Passenger cars,” “drones,” and “Commercial trucks” as the vehicle preferences. For the payment preferences, the third user 550 chose to “Select contract terms” to fund payments. In some cases, the user can select the contract terms through separate processes or negotiations, or may reference contract terms already in place between the user and owner.

It should be understood that the examples illustrated in FIGS. 5A and 5B are not a complete reference of all envisioned user information, autonomous vehicles, capabilities, or preferences.

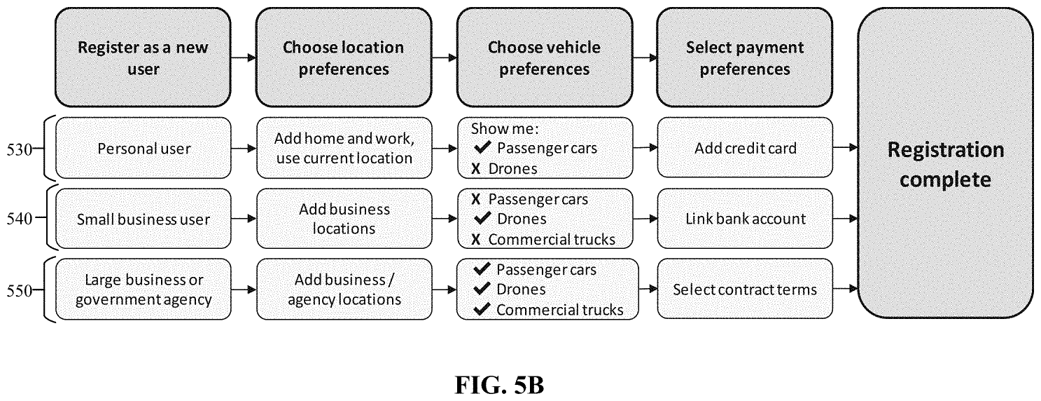

FIGS. 6A-6C illustrate snapshots of an example user interface showing a user scenario of an on demand autonomous vehicle application. Referring to FIGS. 6A-6C, a user may open a user interface (UI) 600 of an on demand autonomous vehicle application (“AV application”) such as described with respect to application 110 of FIG. 1A on their computing device. The computing device may be any computing device such as, but not limited to, a laptop computer, a desktop computer, a tablet, a personal digital assistant, a smart phone, a smart television, a gaming console, a wearable device, and the like.

Referring to FIG. 6A, in some cases, the user may first be asked to sign in to the AV application (not shown). Once the user signs in to the AV application, the AV application may ask the user to define an autonomous vehicle use case. In the illustrative example, a search view 602 of the UI 600 is displayed. Through the search view 602, the user can define the autonomous vehicle use case, for example, by selecting or entering consumer parameters, such as a type of autonomous vehicle, a pick-up and drop-off location, time, features, and a number of passengers or amount of cargo.

As the user starts interacting with the AV application, process 200 as described with respect to FIG. 2 can be initiated. For example, the AV service can receive the consumer parameters for the autonomous vehicle use case defined by the user (e.g., step 205), map the consumer parameters to available autonomous vehicle (e.g. step 210, including step 215, step 220, and step 225)), and provide information of the available autonomous vehicle that is mapped to the consumer parameters (e.g., step 230).

In the illustrative example, the user has entered multiple consumer parameters 605, including a pick-up location (“Pier 23, The Embarcadero, San Francisco, Calif.”), a drop-off location (“123 Main St, San Francisco, Calif.”), a time (“ASAP”), a number of passengers (“4”), and features (“Any”).

In the illustrative example, information for two available autonomous vehicles is provided to the user (e.g., a first available autonomous vehicle 610 and a second available autonomous vehicle 620). In the illustrative example, the first available autonomous vehicle 610 is a “Tesla Model X” that “Seats 5 passengers,” has a “275 mi current range,” and is currently “0.1 mi from current location.” The first available autonomous vehicle 610 has a ride cost of “$15.” The second available autonomous vehicle 620 is a “Ford Fusion” that “Seats 5 passengers,” has a “101 mi current range,” and is currently “1.1 mi from current location.” The second available autonomous vehicle 620 has a ride cost of “$12.”

Each displayed available autonomous vehicle also includes a command to select that available autonomous vehicle, such as choose command 622 for the first available autonomous vehicle 610.

Referring to FIG. 6B, the user has selected the first available autonomous vehicle 610 via the choose command 622 shown in FIG. 6A. The user is presented with a pick-up view 625 of the UI 600. Through the pick-up view 625, the user can follow along as the selected autonomous vehicle travels to the pick-up location. In the illustrative example of FIG. 6B, the information displayed in the pick-up view 625 of the UI 600 includes a status 630 of the selected available autonomous vehicle (“Tesla Model X is en route”), a map 632 showing the current location of the selected autonomous vehicle, and instructions 634 indicating what to do when the selected autonomous vehicle arrives at the pick-up location.

The pick-up view 625 of the UI 600 includes an unlock command 640 and an option command 642. The unlock command 640 becomes usable when the selected autonomous vehicle is in the proximity of the pick-up location. In some cases, selecting the unlock command 640, can allow the user to access the selected autonomous vehicle and begin the ride. The unlock command 640 is received by the service (e.g., service 120 of FIG. 1A), which then communicates via the appropriate API to the vehicle to cause the vehicle to unlock. The unlock command 640 can change to a “begin ride” command after being selected. The option command 642 allows the user to, for example, cancel the ride or change the pick-up location.

Referring to FIG. 6C, once the selected available autonomous vehicle arrives at the pick-up location and the user accesses the vehicle, the user is presented with a drop-off view 645 of the UI 600 displaying information regarding the progress of the ride.

In the illustrative example of FIG. 6C, the information displayed in the drop-off view 645 of the UI 600 includes a status 650 of the selected available autonomous vehicle (“On ride, ETA 1:12 PM”), the drop-off location 652, and a map 654 showing the current location of the selected autonomous vehicle along the route.

The drop-off view 645 of the UI 600 includes a pause command 660 and an options command 662. The pause command 660 causes the selected autonomous vehicle to safely pull over to the side of the road. The options command 662 allows the user to, for example, end the ride or change the drop-off location. Similar to the unlock command 640, when a pause command 660 is selected by the user, the pause command 660 is received by the service, which then communicates via the appropriate API to the vehicle.

In some cases, when the application is provided with the appropriate API information whether pre-programmed in the software of the application (as part of a set of known messages) or by a package sent from the service to the application when the user selects a particular vehicle, the application communicates the commands directly to the autonomous vehicle via the APIs instead of through the service.

It should be understood that other options may be included as appropriate for each autonomous vehicle type, location, and available technology.

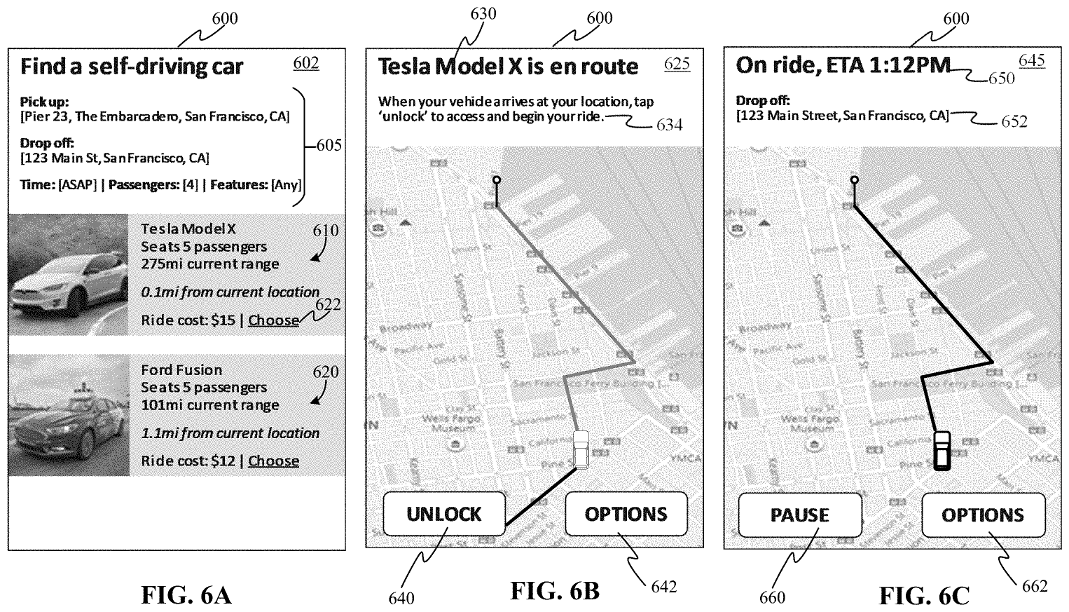

FIGS. 7A-7C illustrate snapshots of an example user interface showing a user scenario of an on demand autonomous vehicle application. Referring to FIGS. 7A-7C a user may open a user interface (UI) 700 of an on demand autonomous vehicle application (“AV application”) such as described with respect to application 110 of FIG. 1A on their computing device. The computing device may be any computing device such as, but not limited to, a laptop computer, a desktop computer, a tablet, a personal digital assistant, a smart phone, a smart television, a gaming console, a wearable device, and the like.

Referring to FIG. 7A, in some cases, the user may first be asked to sign in to the AV application (not shown). Once the user signs in to the AV application, the AV application may ask the user to define an autonomous vehicle use case. In the illustrative example, a search view 702 of the UI 700 is displayed. Through the search view 702, the user can define the autonomous vehicle use case, for example, by selecting or entering consumer parameters, such as a type of autonomous vehicle, a pick-up and drop-off location, time, features, and a number of passengers or amount of cargo.

As the user starts interacting with the AV application, process 200 as described with respect to FIG. 2 can be initiated. For example, the AV service can receive the consumer parameters for the autonomous vehicle use case defined by the user (e.g., step 205), map the consumer parameters to available autonomous vehicle (e.g. step 210, including step 215, step 220, and step 225)), and provide information of the available autonomous vehicle that is mapped to the consumer parameters (e.g., step 230).

In the illustrative example, the user has entered multiple consumer parameters 705, including a pick-up location (“RWJ Hospital Heliport, New Brunswick, N.J.”), a drop-off location (“Morristown Medical Center, Morristown, N.J.”), a time (“ASAP”), and features (“5 kg cargo capacity”).

In the illustrative example, information for two available autonomous vehicles is provided to the user (e.g., a first available autonomous vehicle 710 and a second available autonomous vehicle 720). In the illustrative example, the first available autonomous vehicle 710 is a “DJI M600” drone with a “6 kg cargo capacity” and a “50 mi current range.” The first available autonomous vehicle 710 is currently “12 mi from current location” and has a ride cost of “$95.” The second available autonomous vehicle 720 is a “Carrier HX8” drone with a “45 kg cargo capacity” and a “75 mi current range” The second available autonomous vehicle 720 is currently “26 mi from current location” and has a ride cost of “$240.”

Each displayed available autonomous vehicle also includes a command to select that available autonomous vehicle, such as choose command 722 for the first available autonomous vehicle 710.

Referring to FIG. 7B, the user has selected the first available autonomous vehicle 710 via the choose command 722 shown in FIG. 7A. The user is presented with a pick-up view 725 of the UI 700. Through the pick-up view 725, the user can follow along as the selected autonomous vehicle travels to the pick-up location. In the illustrative example of FIG. 7B, the information displayed in the pick-up view 725 of the UI 700 includes a status 730 of the selected available autonomous vehicle (“En route to pick up”), a map 732 showing the current location of the selected autonomous vehicle, and instructions 734 indicating what to do when the selected autonomous vehicle arrives at the pick-up location.

The pick-up view 725 of the UI 700 includes an unlock command 740 and an options command 742. The unlock command 740 becomes usable when the selected autonomous vehicle is in the proximity of the pick-up location. In some cases, selecting the unlock command 740, can allow the user to access the selected autonomous vehicle and begin the ride. The unlock command 740 is received by the service (e.g., service 120 of FIG. 1A), which then communicates via the appropriate API to the vehicle to cause the vehicle to unlock. The unlock command 740 can change to a “begin flight” command after being selected. The options command 742 allows the user to, for example, cancel the ride or change the pick-up location.

Referring to FIG. 7C, once the selected available autonomous vehicle arrives at the pick-up location and the user accesses the vehicle, the user is presented with a drop-off view 745 of the UI 700 displaying information regarding the progress of the ride.

In the illustrative example of FIG. 7C, the information displayed in the drop-off view 745 of the UI 700 includes a status 750 of the selected available autonomous vehicle (“En route to drop off”), the drop-off location 752, and a map 754 showing the current location of the selected autonomous vehicle along the designated route. While the illustrative example of FIG. 7C shows a direct route, it should be understood that in some cases the route may be circuitous. For example, the route may be circuitous if required to avoid no-fly zones or obstacles. In another example, the route may include required stops for charging if travel beyond the range of the autonomous vehicle is desired.

The drop-off view 745 of the UI 700 includes a return command 760 and an options command 762. The return command 760 causes the selected autonomous vehicle to return to the pick-up location. The options command 762 allows the user to, for example, end the ride or change the drop-off location. Similar to the unlock command 740, when a return command 760 is selected by the user, the return command 760 is received by the service, which then communicates via the appropriate API to the vehicle.

In some cases, when the application is provided with the appropriate API information whether pre-programmed in the software of the application (as part of a set of known messages) or by a package sent from the service to the application when the user selects a particular vehicle, the application communicates the commands directly to the autonomous vehicle via the APIs instead of through the service.

FIG. 8 illustrates components of an example computing device that may be carry out the described processes; and FIG. 9 illustrates components of an example computing system that may be used to implement certain methods and services described herein.

Referring to FIG. 8, system 800 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 800 may be incorporated to implement a particular computing device.

System 800 includes a processing system 805 of one or more processors to transform or manipulate data according to the instructions of software 810 stored on a storage system 815. Examples of processors of the processing system 805 include general purpose central processing units, application specific processors, and logic devices, as well as any other type of processing device, combinations, or variations thereof. The processing system 805 may be, or is included in, a system-on-chip (SoC) along with one or more other components such as network connectivity components, sensors, video display components.

The software 810 can include an operating system (not shown) and application programs such as an on demand autonomous vehicle application 820 that calls the on demand autonomous vehicle service as described herein. Device operating systems generally control and coordinate the functions of the various components in the computing device, providing an easier way for applications to connect with lower level interfaces like the networking interface.

Storage system 815 may comprise any computer readable storage media readable by the processing system 805 and capable of storing software 810 including the on demand autonomous vehicle application 820.

Storage system 815 may include volatile and nonvolatile memories, removable and non-removable media implemented in any method or technology for storage of information, such as computer readable instructions, data structures, program modules, or other data. Examples of storage media of storage system 815 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 815 may be implemented as a single storage device but may also be implemented across multiple storage devices or sub-systems co-located or distributed relative to each other. Storage system 815 may include additional elements, such as a controller, capable of communicating with processing system 805.

Software 810 may be implemented in program instructions and among other functions may, when executed by system 800 in general or processing system 805 in particular, direct system 800 or the one or more processors of processing system 805 to operate as described herein.

The system can further include user interface system 830, which may include input/output (I/O) devices and components that enable communication between a user and the system 800. User interface system 830 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 830 may also include output devices such as display screen(s), speakers, haptic devices for tactile feedback, and other types of output devices. In certain cases, the input and output devices may be combined in a single device, such as a touchscreen, or touch-sensitive, display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display (not shown) in myriad ways, presenting graphical user interface elements, text, images, video, notifications, virtual buttons, virtual keyboards, or any other type of information capable of being depicted in visual form.

The user interface system 830 may also include user interface software and associated software (e.g., for graphics chips and input devices) executed by the OS in support of the various user input and output devices. The associated software assists the OS in communicating user interface hardware events to application programs using defined mechanisms. The user interface system 830 including user interface software may support a graphical user interface, a natural user interface, or any other type of user interface. For example, the user interfaces for the on demand autonomous vehicle application 820 described herein may be presented through user interface system 830.

Network/communications interface 840 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Certain aspects described herein, such as those carried out by the on demand autonomous vehicle service described herein may be performed on a system such as shown in FIG. 9. Referring to FIG. 9, system 900 may be implemented within a single computing device or distributed across multiple computing devices or sub-systems that cooperate in executing program instructions. The system 900 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 900 can include a processing system 910, which may include one or more processors and/or other circuitry that retrieves and executes software 920 from storage system 930. Processing system 910 may be implemented within a single processing device but may also be distributed across multiple processing devices or sub-systems that cooperate in executing program instructions.

Storage system(s) 930 can include any computer readable storage media readable by processing system 910 and capable of storing software 920. Storage system 930 may be implemented as a single storage device but may also be implemented across multiple storage devices or sub-systems co-located or distributed relative to each other. Storage system 930 may include additional elements, such as a controller, capable of communicating with processing system 910.

Software 920, including on demand autonomous vehicle service 945, may be implemented in program instructions and among other functions may, when executed by system 900 in general or processing system 910 in particular, direct the system 900 or processing system 910 to operate as described herein for the on demand autonomous vehicle service 945 (and its various components and functionality).

System 900 may represent any computing system on which software 920 may be staged and from where software 920 may be distributed, transported, downloaded, or otherwise provided to yet another computing system for deployment and execution, or yet additional distribution.

In embodiments where the system 900 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A network/communications interface 950 may be included, providing communication connections and devices that allow for communication between system 900 and other computing systems (not shown) over a communication network or collection of networks (not shown) or the air.

Certain techniques set forth herein with respect to the application and/or sensitivity feature service may be described in the general context of computer-executable instructions, such as program modules, executed by one or more computing devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed by hardware of the computer system (e.g., a processor or processing system), can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
obtaining consumer parameters for an autonomous vehicle use case defined by a user;
mapping the consumer parameters to an available autonomous vehicle by:
querying a data resource for registered autonomous vehicles that satisfy baseline criteria using at least one of the consumer parameters to obtain a scoped set of autonomous vehicles;
obtaining current state information for each autonomous vehicle of the scoped set of autonomous vehicles; and
identifying an autonomous vehicle of the scoped set of autonomous vehicles as the available autonomous vehicle when the current state information of that autonomous vehicle satisfies the autonomous vehicle use case; and
providing information of the available autonomous vehicle that is mapped to the consumer parameters.

2. The method of claim 1, wherein obtaining the current state information for each autonomous vehicle of the scoped set of autonomous vehicles comprises:
communicating with one or more of the autonomous vehicles of the scoped set of autonomous vehicles via their corresponding APIs to obtain the current state information.

3. The method of claim 1, wherein obtaining the current state information for each autonomous vehicle of the scoped set of autonomous vehicles comprises:
determining whether a last known state information for each autonomous vehicle of the scoped set of autonomous vehicles has expired;
for each autonomous vehicle of the scoped set of autonomous vehicles not having expired last known state information, using the last known state information as the current state information; and
for each autonomous vehicle of the scoped set of autonomous vehicles having expired last known state information, communicating with that autonomous vehicle via its corresponding APIs to obtain the current state information.

4. The method of claim 1, wherein information of a plurality of available autonomous vehicles is provided, the method further comprising:
receiving a selection of one of the available autonomous vehicles; and
in response to receiving the selection, facilitating communication via corresponding APIs of the selected available autonomous vehicle to enable action by the selected available autonomous vehicle.

5. The method of claim 4, wherein the facilitating of the communication via the corresponding APIs of the selected available autonomous vehicle to enable the action comprises:
communicating one or more of the consumer parameters via the corresponding APIs, wherein the consumer parameters includes location information and desired action information.

6. The method of claim 4, wherein the facilitating of the communication via the corresponding APIs of the selected available autonomous vehicle to enable the action comprises:
communicating a script via the corresponding APIs, wherein the script is based on the autonomous vehicle use case for the autonomous vehicle defined by the user.

7. The method of claim 4, further comprising:
receiving an option command while the selected available autonomous vehicle is performing the action; and
facilitating communication via the corresponding APIs of the selected available autonomous vehicle to enable the selected autonomous vehicle to perform the option command.

8. The method of claim 7, wherein the option command is a command to pause the action.

9. The method of claim 1, wherein the consumer parameters comprise action information, location information, time information, passenger information, cargo information, feature information, or a combination thereof.

10. A computer readable storage medium having instructions stored thereon that, when executed by a processing system, perform a method comprising:
obtaining consumer parameters for an autonomous vehicle use case defined by a user;
mapping the consumer parameters to an available autonomous vehicle by:
querying a data resource for registered autonomous vehicles that satisfy baseline criteria using at least one of the consumer parameters to obtain a scoped set of autonomous vehicles;
obtaining current state information for each autonomous vehicle of the scoped set of autonomous vehicles; and
identifying an autonomous vehicle of the scoped set of autonomous vehicles as the available autonomous vehicle when the current state information of that autonomous vehicle satisfies the autonomous vehicle use case; and
providing information of the available autonomous vehicle that is mapped to the consumer parameters.

11. The medium of claim 10, wherein obtaining the current state information for each autonomous vehicle of the scoped set of autonomous vehicles comprises:
communicating with one or more of the autonomous vehicles of the scoped set of autonomous vehicles via their corresponding APIs to obtain the current state information.

12. The medium of claim 10, wherein obtaining the current state information for each autonomous vehicle of the scoped set of autonomous vehicles comprises:
determining whether a last known state information for each autonomous vehicle of the scoped set of autonomous vehicles has expired;
for each autonomous vehicle of the scoped set of autonomous vehicles not having expired last known state information, using the last known state information as the current state information; and
for each autonomous vehicle of the scoped set of autonomous vehicles having expired last known state information, communicating with that autonomous vehicle via its corresponding APIs to obtain the current state information.

13. The medium of claim 10, wherein information of a plurality of available autonomous vehicles is provided, the method further comprising:
receiving a selection of one of the available autonomous vehicles; and
in response to receiving the selection, facilitating communication via corresponding APIs of the selected available autonomous vehicle to enable action by the selected available autonomous vehicle.

14. The medium of claim 13, the method further comprising:
receiving an option command while the selected available autonomous vehicle is performing the action; and
facilitating communication via the corresponding APIs of the selected available autonomous vehicle to enable the selected autonomous vehicle to perform the option command.

15. The medium of claim 10, wherein the consumer parameters comprise action information, location information, time information, passenger information, cargo information, feature information, or a combination thereof.

16. A system comprising:
a processing system;
a storage system; and
instructions stored on the storage system that, when executed by the processing system, direct the processing system to:
obtain consumer parameters for an autonomous vehicle use case defined by a user;
map the consumer parameters to an available autonomous vehicle by:
querying a data resource for registered autonomous vehicles that satisfy baseline criteria using at least one of the consumer parameters to obtain a scoped set of autonomous vehicles;
obtaining current state information for each autonomous vehicle of the scoped set of autonomous vehicles; and
identifying an autonomous vehicle of the scoped set of autonomous vehicles as the available autonomous vehicle when the current state information of that autonomous vehicle satisfies the autonomous vehicle use case; and
provide information of the available autonomous vehicle that is mapped to the consumer parameters.

17. The system of claim 16, wherein the instructions to obtain the current state information for each autonomous vehicle of the scoped set of autonomous vehicles direct the processing system to:
communicate with one or more of the autonomous vehicles of the scoped set of autonomous vehicles via their corresponding APIs to obtain the current state information.

18. The system of claim 16, wherein the instructions to obtain the current state information for each autonomous vehicle of the scoped set of autonomous vehicles direct the processing system to:
determine whether a last known state information for each autonomous vehicle of the scoped set of autonomous vehicles has expired;
for each autonomous vehicle of the scoped set of autonomous vehicles not having expired last known state information, use the last known state information as the current state information; and
for each autonomous vehicle of the scoped set of autonomous vehicles having expired last known state information, communicate with that autonomous vehicle via its corresponding APIs to obtain the current state information.

19. The system of claim 16, wherein information of a plurality of available autonomous vehicles is provided, wherein the instructions further direct the processing system to:
receive a selection of one of the available autonomous vehicles; and
in response to receiving the selection, facilitate communication via corresponding APIs of the selected available autonomous vehicle to enable action by the selected available autonomous vehicle.

20. The system of claim 19, wherein the instructions further direct the processing system to:
receive an option command while the selected available autonomous vehicle is performing the action; and
facilitate communication via the corresponding APIs of the selected available autonomous vehicle to enable the selected available autonomous vehicle to perform the option command.
